(19) United States
(12) Patent Application Publication
(10) Pub. No.: US 2005/0245293 A1
(43) Pub. Date: Nov. 3, 2005

(54) Computer keyboard having hybrid computer/telephone keypad

(76) Inventors: Mike Provencher, Cypress, TX (US); Kent Biggs, Tomball, TX (US)

Correspondence Address: HEWLETT-PACKARD COMPANY;Intellectual Property Administration, P.O. Box 272400, Fort Collins, CO, 80527-2400, US

(21) Appl. No.: 10/837,018

(22) Filed: Apr. 30, 2004

(51) Int. Cl. H04B 1/38

(52) U.S. Cl. 455/575.1; 455/90.2

(57) ABSTRACT

A computer keyboard includes a keypad having upper, middle and lower rows, each row having at least three keys. The keypad is capable of operating in a PC mode and a telephone mode. In a PC/numeric submode, keys in the upper row correspond to the numbers 7-9 and keys in the lower row correspond to the numbers 1-3. In a PC/cursor-control submode, at least one key in each row corresponds to a cursor control command. In the telephone mode, keys in the upper row correspond to the numbers 1-3 and keys in the lower row correspond to the numbers 7-9.

### FIELD OF THE INVENTION

This invention relates generally to keyboards for computer systems.

### BACKGROUND

In addition to the number keys disposed along the top row of a QWERTY-style keypad, most computer keyboards also provide a separate keypad as shown in FIG. 1. Telephones, on the other hand, provide a keypad as shown in FIG. 2. Numbers on the computer keypads increase from bottom to top, while numbers on the telephone keypads increase from top to bottom (with the exception of the 0 key which is disposed on the bottom row).

Computers have been used for years in telephony applications. In some telephony applications, the computer keypad is used to dial telephone numbers. For this reason, it has long been an annoyance that the keypad layout differs between computer keyboards and telephone keypads.

### SUMMARY OF THE INVENTION

In one aspect, a computer keyboard according to a preferred embodiment of the invention includes a keypad having upper, middle and lower rows, each row having at least three keys. The keypad is capable of operating in a PC mode and a telephone mode. The PC mode includes PC/numeric and PC/cursor-control submodes such that, in the PC/numeric submode, keys in the upper row correspond to the numbers 7-9 and keys in the lower row correspond to the numbers 1-3 and, in the PC/cursor-control submode, at least one key in each of the upper, middle and lower rows corresponds to a cursor control command. In the telephone mode, keys in the upper row correspond to the numbers 1-3 and keys in the lower row correspond to the numbers 7-9.

In another aspect, a computer keyboard according to a preferred embodiment of the invention includes a keypad having upper, middle and lower rows, each row having at least three keys. The keypad is capable of operating in first and second modes. In the first mode, keys in the upper row correspond to the numbers 7-9 and keys in the lower row correspond to the numbers 1-3 and, in the second mode, the keys in the upper row correspond to the numbers 1-3 and the keys in the lower row correspond to the numbers 7-9.

### BRIEF DESCRIPTION OF THE DRAWINGS

FIG. 1 is a plan view illustrating a number keypad on a computer keyboard according to the prior art.

FIG. 2 is a plan view illustrating a telephone keypad according to the prior art.

FIG. 3 is a plan view illustrating a hybrid keypad on a computer keyboard according to a preferred embodiment of the invention.

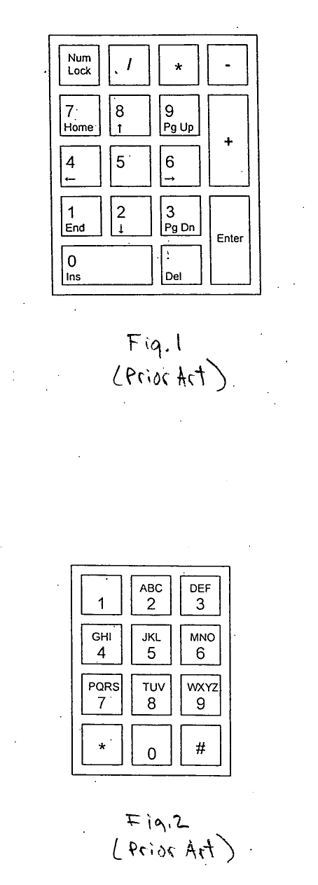

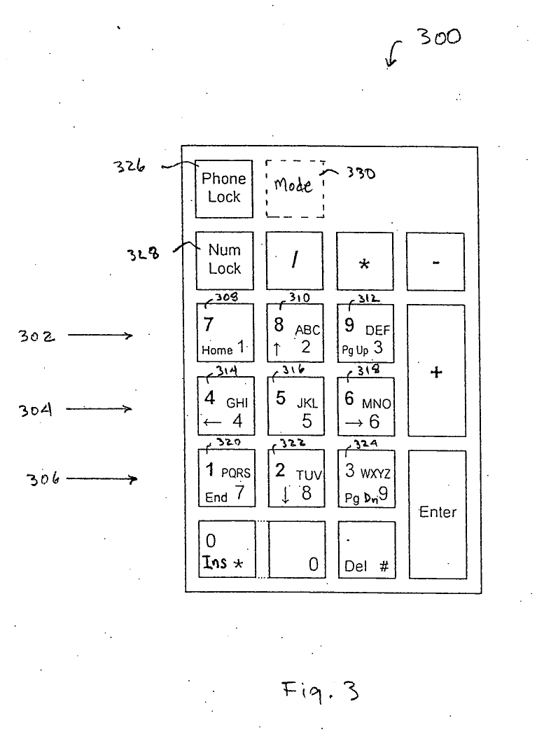

### DETAILED DESCRIPTION OF THE PREFERRED EMBODIMENTS

A computer keyboard according to a preferred embodiment of the invention includes a hybrid computer/telephone keypad such as keypad 300 shown in FIG. 3. Keypad 300 includes an upper row of keys 302, a middle row of keys 304 and a lower row of keys 306. Upper row includes at least three keys 308, 310, 312. Middle row includes at least three keys 314, 316, 318. And lower row includes at least three keys 320, 322, 324.

Keypad 300 is capable of operating in a personal computer (“PC”) mode and in a telephone mode. The PC mode includes a PC/numeric submode and a PC/cursor-control submode. In the PC/numeric submode, keys 308-312 in upper row 302 correspond to the numbers 7-9, and keys 320-324 in lower row 306 correspond to the numbers 1-3. In the PC/cursor-control mode, at least one of the keys in each of rows 302, 304 and 306 corresponds to a cursor-control command. For example, keys 310, 314, 318 and 322 may correspond to cursor up, left, right and down, respectively. And keys 308, 312, 320 and 324 may correspond to cursor home, page up, end and page down, respectively. In the telephone mode, keys 308-312 in upper row 302 correspond to the numbers 1-3, and keys 320-324 in lower row 306 correspond to the numbers 7-9.

The keys of keypad 300 may include labels corresponding to each of the telephone, PC/numeric and PC/cursor-control modes as shown by way of illustration in FIG. 3.

Keypad 300 maybe implemented so that it switches from one mode to another responsive to any means now known or yet to be devised. For example: In one embodiment, keypad 300 may enter and exit the telephone mode responsive to a phone-lock key 326 located somewhere on the host keyboard. Phone-lock key 326 need not be located on keypad 300 itself. Keypad 300 may cycle between the telephone mode and the PC mode responsive to phone-lock key 326. In another embodiment, keypad 300 may enter and exit the telephone mode responsive to the state of an off-hook indicator of a host computer or a telephone. The off-hook indicator may be connected to the cradle switch of a telephone, or may be connected to a switch on an audio headset or the like, or may be implemented as an actual or virtual keyboard key. In another embodiment, keypad 300 may enter and exit the telephone mode programmatically responsive to a user interface of the host computer. In another embodiment, keypad 300 may enter and exit the telephone mode responsive to a speaker phone key or some other telephony mode key. In another embodiment, keypad 300 may enter and exit the telephone mode responsive to a logical state of the host computer (such as, for example, the window active state of a telephony application). In yet another embodiment, keypad 300 may cycle between the PC/numeric mode and the telephone mode responsive to a mode key 330 located somewhere on the keyboard. Mode key 330 need not be located on keypad 300 itself. Or keypad 300 may cycle between the PC/numeric mode, the PC/cursor-control mode and the telephone mode responsive to mode key 330. Other such variations are also possible.

When keypad 300 is not in the telephone mode, it may cycle between the PC/numeric mode and the PC/cursor-control mode responsive to the state of a num-lock key 328 as it would in a conventional computer keyboard.

All of the above and other embodiments of the invention may be created using any of numerous techniques known to persons having ordinary skill in the art. For example, a state machine may be used to report different codes to a host computer for a given key on keypad 300 (via a suitable host-keyboard interface) depending on the current mode of keypad 300.

A computer keyboard according to the invention provides numerous advantages over the computer keyboards of the prior art. One such advantage is that computer users who are habituated to the layout of the keys on telephone keypads need not break with habit when dialing telephone numbers with the computer keypad and vice versa. In addition, this convenience is provided without the added expense, space and power requirements that would be associated with providing two separate keypads-one having a computer layout and one having a telephone layout. Moreover, the invention may be implemented on any type of computer keyboard including, without limitation, the popular serial, PS/2, USB or wireless types of keyboards.

While the invention has been described in detail with reference to preferred embodiments thereof, the described embodiments have been presented by way of example and not by way of limitation. It will be understood by those skilled in the art that various changes may be made in the form and details of the described embodiments without deviating from the spirit and scope of the invention as defined by the appended claims.

1. A computer keyboard, comprising:
a keypad having upper, middle and lower rows, each row having at least three keys;
wherein the keypad is capable of operating in a PC mode and a telephone mode such that:
the PC mode comprises PC/numeric and PC/cursor-control submodes such that, in the PC/numeric submode, keys in the upper row correspond to the numbers 7-9 and keys in the lower row correspond to the numbers 1-3 and, in the PC/cursor-control submode, at least one key in each of the upper, middle and lower rows corresponds to a cursor control command; and
in the telephone mode, keys in the upper row correspond to the numbers 1-3 and keys in the lower row correspond to the numbers 7-9.

2. The computer keyboard of claim 1, further comprising:
means for switching the keypad between the telephone mode and the PC mode.

3. The computer keyboard of claim 1:
wherein the keypad enters and exits the telephone mode responsive to a phone-lock key on the keyboard.

4. The computer keyboard of claim 1:
wherein the keypad enters and exits the telephone mode responsive to the state of an off-hook indicator.

5. The computer keyboard of claim 1:
wherein the keypad enters and exits the telephone mode programmatically responsive to a user interface of a host computer.

6. The computer keyboard of claim 1:
wherein the keypad enters and exits the telephone mode responsive to a speaker phone key.

7. The computer keyboard of claim 1:
wherein the keypad enters and exits the telephone mode responsive to a telephony mode key.

8. The computer keyboard of claim 1:
wherein the keypad enters and exits the telephone mode responsive to a logical state of a host computer.

9. The computer keyboard of claim 1:
wherein the keypad enters and exits the telephone mode responsive to a mode key.

10. The computer keyboard of claim 1:
wherein the keypad cycles between the telephone mode, the PC/numeric mode and the PC/cursor-control mode responsive to a mode key.

11. The computer keyboard of claim 1:
wherein, when not in the telephone mode, the keypad cycles between the PC/numeric and PC/cursor-control submodes responsive to a num-lock key on the keyboard.

12. The computer keyboard of claim 1:
wherein keys of the keypad comprise labels corresponding to the telephone mode and the PC modes.

13. A computer keyboard, comprising:
a keypad having upper, middle and lower rows, each row having at least three keys;
wherein the keypad is capable of operating in first and second modes such that, in the first mode, keys in the upper row correspond to the numbers 7-9 and keys in the lower row correspond to the numbers 1-3 and, in the second mode, the keys in the upper-row correspond to the numbers 1-3 and the keys in the lower row correspond to the numbers 7-9.

14. The computer keyboard of claim 13:
wherein the keypad is capable of operating in a third mode in which at least one of the keys in the upper, middle and lower rows corresponds to a cursor control command.

15. The computer keyboard of claim 13, further comprising:
means for switching the keypad between the first and second modes.

16. The computer keyboard of claim 13:
wherein the keypad changes modes responsive to a phone lock key on the keyboard.

17. The computer keyboard of claim 13:
wherein the keypad changes modes responsive to the state of an off-hook indicator.

18. The computer keyboard of claim 13:
wherein the keypad changes modes programmatically responsive to a user interface of a host computer.

19. The computer keyboard of claim 13:
wherein the keypad changes modes responsive to a speaker phone key.

20. The computer keyboard of claim 13:
wherein the keypad changes modes responsive to a telephony mode key.

21. The computer keyboard of claim 13:
wherein the keypad changes modes responsive to a logical state of a host computer.

22. The computer keyboard of claim 13:
wherein the keypad cycles between the first and second modes responsive to a mode key on the keyboard.

23. The computer keyboard of claim 14:
wherein the keypad cycles between the first, second and third modes responsive to a mode key on the keyboard.

24. The computer keyboard of claim 13:
wherein keys of the keypad comprise labels corresponding to each of the first and second modes.

25. The computer keyboard of claim 14:
wherein keys of the keypad comprise labels corresponding to each of the first, second and third modes.
